(19) United States
(12) Patent Application Publication
(10) Pub. No.: US 2020/0203860 A1
(43) Pub. Date: Jun. 25, 2020

(54) COAXIAL CABLE CONNECTOR PROVIDED WITH A HOUSING COMPRISING PAIRED CRIMPING PIECES

(71) Applicant: Hirose Electric Co., Ltd., Tokyo (JP)

(72) Inventor: Yujin HAGA, Tokyo (JP)

(73) Assignee: Hirose Electric Co., Ltd.

(21) Appl. No.: 16/715,221

(22) Filed: Dec. 16, 2019

(30) Foreign Application Priority Data
Dec. 21, 2018 (JP) 2018-239702

(51) Int. Cl. H01R 9/05; H01R 43/048

(52) U.S. Cl. CPC H01R 9/0518; H01R 43/048

(57) ABSTRACT

The connector is provided with a terminal, a housing that supports the terminal, and an outer conductor shell that covers the exterior of the housing. The terminal includes a connecting portion exposed from the housing, and the outer conductor shell includes a first and second crimping portion provided in a manner permitting deformation toward a coaxial cable connected to the connecting portion and successively spaced apart from each other along the axial direction of the coaxial cable connected to the connecting portion from one end toward the other end of the coaxial cable. The first crimping portion involves protruding portions positioned in the axial direction at the corresponding locations of the connecting portion and protrudes in the axial direction toward the second crimping portion. The second crimping portion involves, in alignment with the protruding portions, indented portions indented away from the first crimping portion in the axial direction.

### CROSS-REFERENCE TO RELATED APPLICATIONS

This application claims priority to Japanese Patent Application No. 2018-239702, filed Dec. 21, 2018, the contents of which are incorporated herein by reference in its entirety for all purposes.

### BACKGROUND

### Technical Field

The present invention relates to a coaxial cable connector and, more particularly, to a coaxial cable connector provided with a housing comprising paired crimping pieces.

### Related Art

An exemplary conventional coaxial cable connector is illustrated in Japanese Patent No. 6,379,403 (Patent Document 1). This coaxial cable connector consists essentially of a terminal, a housing that supports the terminal, and an outer conductor shell that covers at least a portion of the housing. A portion of the terminal is provided exposed from the housing as a contact portion that is brought in contact with a terminal in a counterpart coaxial cable connector and, in addition, as a connecting portion to which the core wire of a coaxial cable is connected. The housing comprises paired crimping pieces provided on each of the opposed sides that sandwich a mounting surface that forms part of the connecting portion, in a manner permitting rotation toward the mounting surface, centered about folds. The core wire of a coaxial cable mounted to the mounting surface can be crimped and connected to the mounting surface by rotating the crimping pieces toward the mounting surface. For example, such crimping and connection can be accomplished by crimping a portion of the outer conductor shell and then rotating the crimping pieces through abutment against said portion.

The outer conductor shell includes a front crimping portion, an intermediate crimping portion, and a rear crimping portion, with each of these consisting of a pair of pieces. The front crimping portion, intermediate crimping portion, and rear crimping portion are deformable toward the coaxial cable connected to the connecting portion at one end and are provided adjacent to each other in succession from one end toward the other end of the coaxial cable. Here, the front crimping portion is used mainly to crimp the crimping pieces, the intermediate crimping portion is used mainly to crimp the outer conductor, and the rear crimping portion is used mainly to crimp the insulating jacket.

### RELATED ART DOCUMENT

### Patent Documents

### [Patent Document 1]

Japanese Patent No. 6,379,403.

### SUMMARY

### Problems to be Solved

To improve the radio-frequency characteristics of a coaxial cable connector it is particularly preferable for the core wire of the coaxial cable to be completely covered by the outer conductor shell. However, the construction used in the conventional configuration of Patent Document 1 and the like was such that much of the core wire and the insulator was not covered by the outer conductor shell or the outer conductor (braid).

It is an object to provide a coaxial cable connector in which the area where the core wire of the coaxial cable is covered by the outer conductor shell is expanded. The invention of the present Application has been devised to solve such problems of the prior art and it is an object of the invention to provide a coaxial cable connector in which the area where the core wire of the coaxial cable is covered by the outer conductor shell is expanded.

### Technical Solution

The inventive coaxial cable connector is characterized by the fact that it is a coaxial cable connector provided with a terminal, a housing that supports the terminal, and an outer conductor shell that covers the exterior of the housing, wherein the terminal comprises a connecting portion exposed from the housing; the outer conductor shell comprises a first crimping portion and a second crimping portion provided in a manner permitting deformation toward a coaxial cable connected to the connecting portion and successively spaced apart from each other along the axial direction of the coaxial cable connected to the connecting portion from one end toward the other end of the coaxial cable; the first crimping portion comprises protruding portions that are positioned in the axial direction at the corresponding locations of the connecting portion and protrude in the axial direction toward the second crimping portion; and the second crimping portion comprises, in alignment with the protruding portions, indented portions indented away from the first crimping portion in the axial direction.

Such a configuration makes it possible to provide a coaxial cable connector in which protruding portions and indented portions are employed to expand, in particular, the area where the core wire of the coaxial cable is covered by the outer conductor shell.

In the coaxial cable connector of the embodiment described above, both the first crimping portion and the second crimping portion may be comprised by paired crimping pieces provided in a manner permitting deformation toward the coaxial cable connected to the connecting portion; each of the crimping pieces constituting the paired crimping pieces, on each of the opposed sides that sandwich the connecting portion, may have an abutting face brought into abutment against a counterpart crimping piece upon deformation toward the coaxial cable connected to the connecting portion; and convex portions, which engage with recessed portions provided on the abutting face of a counterpart crimping piece when the paired crimping pieces are deformed toward the coaxial cable connected to the connecting portion, may be provided on at least one of the abutting faces of the paired crimping pieces.

In addition, in the coaxial cable connector of the embodiment described above, on one of the opposed sides that sandwich the connecting portion, moreover, on the side where the first crimping portion and the second crimping portion are adjacent to each other, the convex portions may be provided on the abutting face of one crimping piece of the first crimping portion and the recessed portions may be provided on the abutting face of one crimping piece of the second crimping portion; and, on the other one of the opposed sides that sandwich the connecting portion, moreover, on the side where the first crimping portion and the second crimping portion are adjacent to each other, the recessed portions may be provided on the abutting face of the other crimping piece of the first crimping portion and the convex portions may be provided on the abutting face of the other crimping piece of the second crimping portion.

Furthermore, in the coaxial cable connector of the embodiment described above, upon deformation of each crimping piece constituting the paired crimping pieces toward the coaxial cable connected to the connecting portion, the convex and recessed portions may be engaged with each other in a circumferential direction about the axial line of the coaxial cable at the corresponding locations of the connecting portion.

In addition, in the coaxial cable connector of the embodiment described above, upon deformation of each crimping piece constituting the paired crimping pieces toward the coaxial cable connected to the connecting portion, the length of the first crimping portion in the width direction connecting one of the opposed sides that sandwich the connecting portion and the other side may be longer than the length of the second crimping portion in the width direction, and a stepped portion may be formed in the axial direction between the first crimping portion and the second crimping portion.

In addition, in the coaxial cable connector of the embodiment described above, the first crimping portion and the second crimping portion of the outer conductor shell may be formed from a single metal sheet.

### Technical Effect

In accordance with this invention, a coaxial cable connector is provided in which the area where the core wire of the coaxial cable is covered by the outer conductor shell is expanded.

### BRIEF DESCRIPTION OF THE DRAWINGS

FIG. 1

A perspective view of the inventive coaxial cable connector.

FIG. 2

A plan view of the coaxial cable connector of FIG. 1.

FIG. 3

A side view of the coaxial cable connector of FIG. 1.

FIG. 4

An exploded perspective view of the coaxial cable connector of FIG. 1.

FIG. 5

A drawing illustrating some of the steps in the fabrication of the outer conductor shell.

FIG. 6

A side view of the outer conductor shell where a metal sheet has been folded to produce the state of FIG. 4.

FIG. 7

A perspective view illustrating a state immediately prior to crimping the paired crimping pieces to the coaxial cable disposed on an arrangement surface.

FIG. 8

A plan view of FIG. 7.

FIG. 9

A partial enlarged view of one of the gaps illustrated in FIG. 5.

FIG. 10

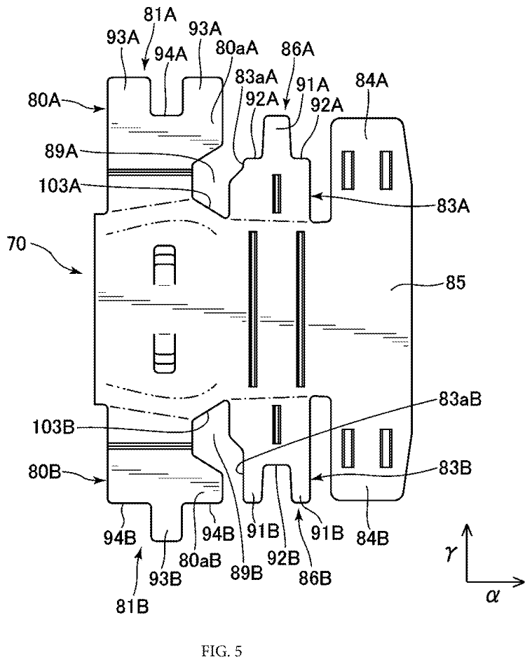

A partial enlarged view of the other gap illustrated in FIG. 5.

### DETAILED DESCRIPTION

A preferred embodiment of the present invention will be described below with reference to the accompanying drawings. While the discussion below refers to so-called right-angle coaxial connectors, the present invention is not limited thereto and, for example, can also be applied to cable connectors of the vertical type.

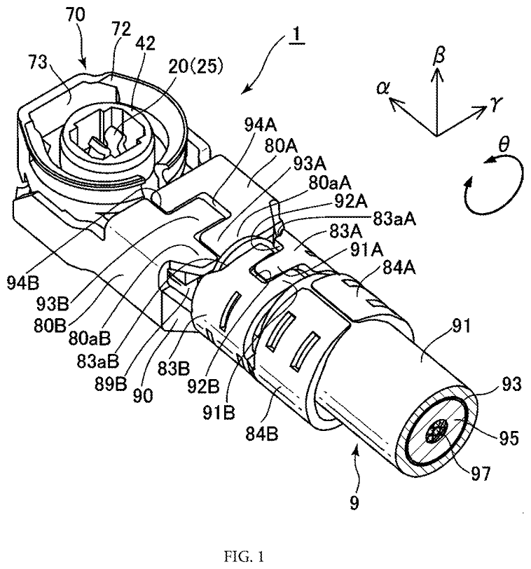

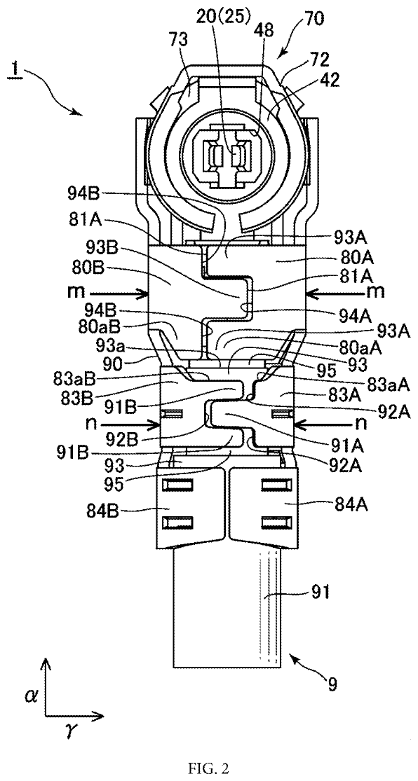

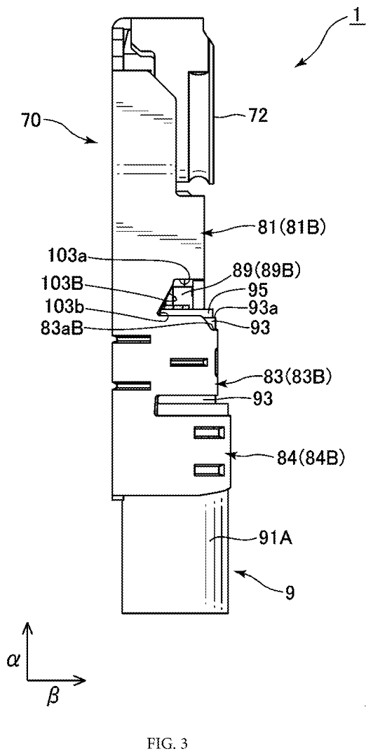

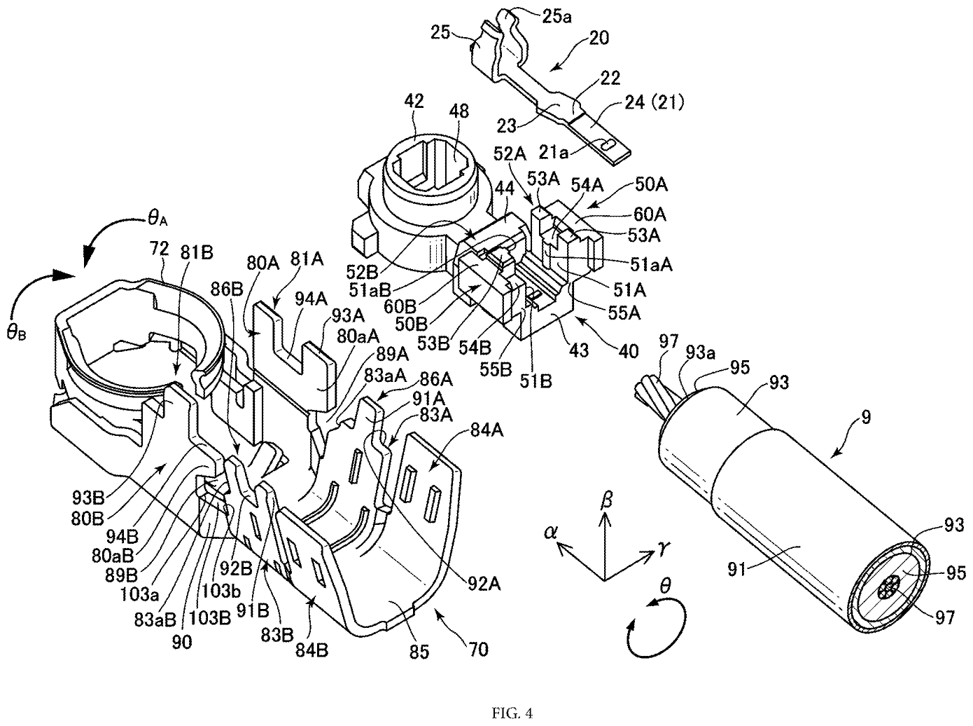

A perspective view of the inventive coaxial cable connector 1 is shown in FIG. 1, its plan view in FIG. 2, its side view in FIG. 3, and its exploded perspective view in FIG. 4. The coaxial cable connector 1 can be mated with a counterpart coaxial connector (not shown in the drawing) in the mating direction “0”.

The coaxial cable connector 1 is provided with an electrically conductive terminal 20, an insulative housing 40 that supports the terminal 20, and an outer conductor shell 70 that covers at least a portion of the exterior of the coaxial cable (not shown in the drawing) and the housing 40.

The terminal 20 has a predetermined length in the axial direction “a” of the coaxial cable 9 secured to the coaxial cable connector 1. The coaxial cable 9 is of the same construction as a regular conventional coaxial cable; in other words, it has an insulating jacket 91, an outer conductor (braid) 93, an insulator 95, and a core wire 97 arranged in the direction from the outermost shell to the center. The core wire 97 is exposed at one end of the coaxial cable 9. A contact portion 25, which is placed in contact with a center terminal in a counterpart coaxial connector, is provided at the distal end of the terminal 20. Portions, 25a, of the contact portion 25 are raised toward the side of contact with a counterpart coaxial connector and are formed as paired resilient pieces allowing for the center terminal of the counterpart coaxial connector to be inserted and sandwiched therebetween. A connecting portion 24, which is connected to the core wire 97 exposed at one end of the coaxial cable 9, is provided at the rear end of the terminal 20. A mounting surface 21, to which the core wire 97 of the coaxial cable is mounted, is formed on the surface of the connecting portion 24. A wide stepped portion 23, which has a step in the mating direction “β” and also expands in the width direction “γ”, is provided between the contact portion 25 and the connecting portion 24. As a result of providing a step in the mating direction “β”, the rear end side (24) of the terminal 20 in the integrally molded housing 40 is located closer to the coaxial cable than the front end side (25), while the front end side (25) of the terminal 20 is located closer to the arrangement surface 85 of the outer conductor shell 70 than the rear end side (24).

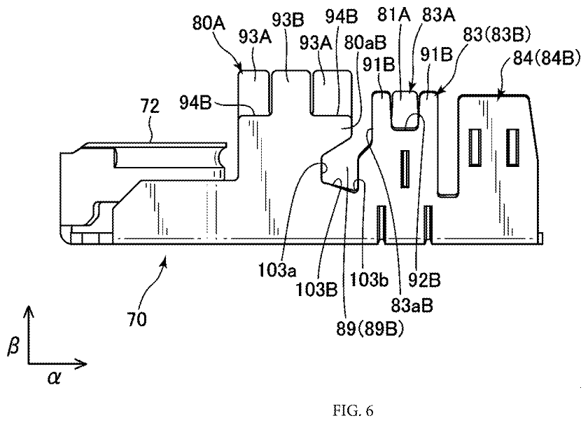

The outer conductor shell 70 is formed by stamping and folding from a generally rectangular piece of sheet metal. FIG. 5 is a plan view illustrating some of the steps in the fabrication of the outer conductor shell and, in addition, the state obtained immediately after stamping from a metal sheet. The outer conductor shell 70 consists essentially of the arrangement surface 85, on which the housing 40 and the coaxial cable 9 are disposed, a substantially cylindrical mating portion 72 provided at the distal end of this arrangement surface 85, as well as multiple crimping portions, more specifically, an enclosing portion 80, which is positioned at a corresponding location of the connecting portion 24 along the axial direction “a”, and, also, an outer conductor crimping portion 83 and a jacket crimping portion 84, which are disposed so as to be spaced apart from one another along the axial direction “a” from one end toward the other end of the coaxial cable 9 connected to the connecting portion 24. As can be seen from this drawing, each component contained in the outer conductor shell 70 falls within the bounds of a generally rectangular metal sheet used for stamping. For this reason, much of the metal sheet can be efficiently utilized and material costs can be lowered. FIG. 6 shows a side view of the outer conductor shell 70 obtained by folding the metal sheet of FIG. 5 to produce the state of FIG. 4 and, furthermore, a side view of the outer conductor shell 70 immediately prior to crimping. In this state, the enclosing portion 80, the outer conductor crimping portion 83, and the jacket crimping portion 84 extend in the “0” direction with respect to the same planar arrangement surface 85. In the “0” direction, the size of the enclosing portion 80 is smaller than that of the insulator 95 of the coaxial cable 9 and, in addition, the size of the outer conductor crimping portion 83 is larger than that of the enclosing portion 80 and the size of the outer conductor crimping portion 83 is larger than that of the jacket crimping portion 84. Using such dimensional relationships facilitates electrical matching to suit the diameter of the coaxial cable.

At the time of mating with a counterpart coaxial connector, the mating portion 72 is connected to the cylindrical shell of the counterpart coaxial connector (not shown in the drawing). The cylindrical shell of the counterpart coaxial connector is inserted into a gap 73 formed between the mating portion 72 of the outer conductor shell 70 and the mating portion 42 of the housing 40.

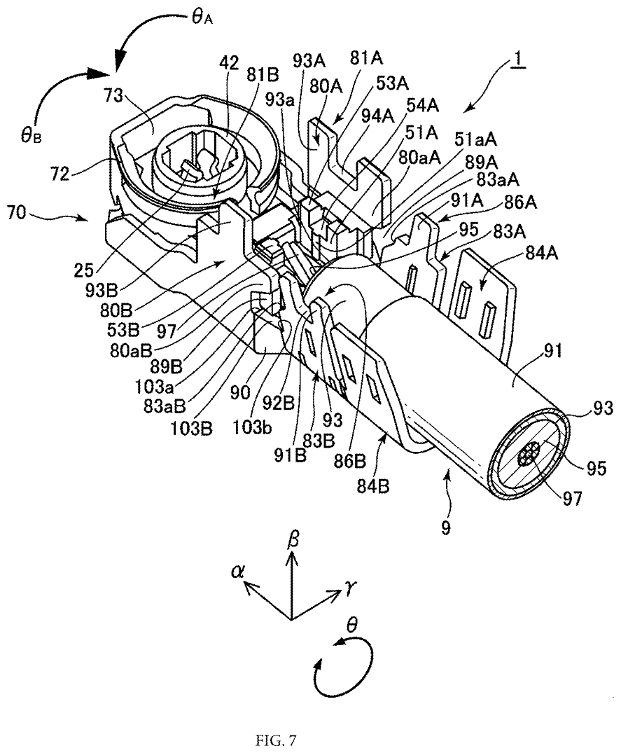

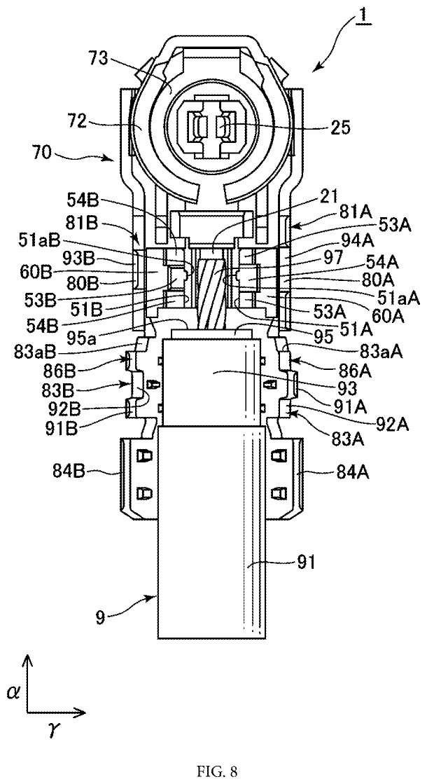

Each of the three crimping portions, i.e., the enclosing portion (first crimping portion) 80, the outer conductor crimping portion (second crimping portion) 83, and the jacket crimping portion 84, is comprised by paired crimping pieces provided so as to permit deformation toward the coaxial cable 9 connected to the connecting portion 24, these being enclosing pieces 80A, 80B, outer conductor crimping pieces 83A, 83B, and jacket crimping pieces 84A, 84B. FIG. 7 is a perspective view illustrating a state immediately prior to crimping the enclosing pieces 80A, 80B, the outer conductor crimping pieces 83A, 83B, and the jacket crimping pieces 84A, 84B to the coaxial cable 9 disposed on the arrangement surface 85, and FIG. 8 is a plan view thereof. Here (and elsewhere), the letters “A” and “B” indicate the right and left sides.

The crimping pieces that constitute each pair are disposed respectively on each of the opposed sides that sandwich the arrangement surface 85, in other words, on each of the opposed sides that sandwich the connecting portion 24 (mounting surface 21). The enclosing pieces 80A, 80B are intended mainly for securing the core wire 97 of the coaxial cable by crimping the crimping pieces 50A, 50B of the housing 40, the outer conductor crimping pieces 83A, 83B are intended mainly for crimping the outer conductor 93 of the coaxial cable 9, and the jacket crimping pieces 84A, 84B are intended mainly for crimping the insulating jacket 91 of the coaxial cable 9. When the coaxial cable 9 is disposed in the outer conductor shell 70, the core wire 97 of the coaxial cable 9 is mounted to the mounting surface 21 of the terminal 20 and positioned at a location corresponding to the enclosing pieces 80A, 80B, the outer conductor 93 of the coaxial cable 9 is positioned at a location corresponding to the outer conductor crimping pieces 83A, 83B, and, in addition, the insulating jacket 91 of the coaxial cable 9 is positioned at a location corresponding to the jacket crimping pieces 84A, 84B. The crimping pieces that constitute each pair are deformed at the respective locations toward the coaxial cable 9 in the “θ_{A}” or “θ_{B}” direction and are crimped onto said coaxial cable 9. It should be noted that in the state illustrated in FIG. 4 and FIG. 6, the locations where the enclosing pieces 80A, 80B are folded is slightly different from the locations where they undergo draw-bending during crimping to the coaxial cable 9. In FIG. 5, the locations where the enclosing pieces 80A, 80B are folded, along with the locations where the outer conductor crimping pieces 83A, 83B are folded, are shown with a one-dot chain line. In addition, the locations where the enclosing pieces 80A, 80B undergo draw-bending are shown with a two-dot chain line.

The enclosing portion 80 includes abutting faces 81A, 81B (surfaces formed by the “α” and “γ” directions in FIG. 4, FIG. 7, and FIG. 8), which are brought into abutment against a counterpart enclosing piece when the paired enclosing pieces 80A, 80B are folded and rotated.

Similarly, the outer conductor crimping portion 83 includes abutting faces 86A, 86B, which are brought into abutment against a counterpart outer conductor crimping piece when the paired outer conductor crimping pieces 83A, 83B are similarly rotated.

Recessed portions 94A, 94B, which engage with the convex portions 93A, 93B provided on the abutting faces 81A, 81B of the enclosing pieces 80A, 80B when the paired enclosing pieces 80A, 80B are similarly rotated, are provided on at least one of the abutting faces 81A, 81B of the paired enclosing pieces 80A, 80B. In the illustrated example, a total of three portions, i.e., a convex portion 93A, a recessed portion 94A, and a convex portion 93A, are provided in this order in an alternating manner along the axial direction “α” on the abutting face 81A and, in alignment therewith, a total of three portions, i.e., a recessed portion 94B, a convex portion 93B, and a recessed portion 94B, are similarly provided in this order on the abutting face 81B. There are no specific limitations as to the number of such recessed and convex portions, such that only one recessed or convex portion, or a plurality of recessed and convex portions, may be provided on each of the abutting faces 81A, 81B.

In the same manner, recessed portions 92A, 92B, which engage with convex portions 91A, 91B provided on the abutting faces 86A, 86B of the outer conductor crimping pieces 83A, 83B when the paired outer conductor crimping pieces 83A, 83B are rotated, are provided on at least one of the abutting faces 86A, 86B of the paired outer conductor crimping pieces 83A, 83B. In the illustrated example, a total of three portions, i.e., a recessed portion 92A, a convex portion 91A, and a recessed portion 92A, are provided in this order in an alternating manner along the axial direction “α” on the abutting face 86A and, in alignment therewith, a total of three portions, i.e., a convex portion 91B, a recessed portion 92B, and a convex portion 91B, are similarly provided in this order on the abutting face 86B. There are no specific limitations as to the number of such recessed and convex portions, such that only one recessed or convex portion, or a plurality of recessed and convex portions, may be provided on each of the abutting faces 86A, 86B.

As best shown in FIG. 2, when these enclosing pieces 80A, 80B and the outer conductor crimping pieces 83A, 83B are respectively deformed toward the coaxial cable 9 connected to the connecting portion 24, in the enclosing pieces 80A, 80B, the convex portion 93A, the recessed portion 94A, and the convex portion 93A provided on the abutting face 81A of the enclosing piece 80A are respectively engaged with the recessed portion 94B, the convex portion 93B, and the recessed portion 94B provided on the abutting face 81B of the enclosing piece 80B. In addition, in the outer conductor crimping pieces 83A, 83B, the recessed portion 92A, the convex portion 91A, and the recessed portion 92A provided on the abutting face 86A of the outer conductor crimping piece 83A are similarly engaged with the convex portion 91B, the recessed portion 92B, and the convex portion 91B provided on the abutting face 86B of the outer conductor crimping piece 83B at corresponding locations of the connecting portion 24 in the circumferential direction “θ” about the axial line of the coaxial cable 9. It should be noted that it is sufficient for such recessed and convex portions to be adapted for mutual engagement, and that the order of the recessed and convex portions provided on the abutting face 81A of the enclosing piece 80A and the order of the recessed and convex portions provided on the abutting face 81B of the enclosing piece 80B may be transposed. In a similar manner, the order of the recessed and convex portions provided on the abutting face 86A of the outer conductor crimping piece 83A and the order of the recessed and convex portions provided on the abutting face 86B of the outer conductor crimping piece 83B may be transposed.

When the crimping pieces that constitute each pair are deformed at the respective locations toward the coaxial cable 9 and crimped onto to the coaxial cable 9, the width “m” of the enclosing portion 80 in the width direction “γ” connecting the one side “A” and the other side “B” that sandwich the connecting portion 24 is greater than the width “n” of the outer conductor crimping portion 83 in the width direction “γ”, and a stepped portion 90 is formed along the axial direction “α” between the enclosing portion 80 and the outer conductor crimping portion 83. This stepped portion 90 may be due to differences in the diameter of the core wire 97 of the coaxial cable 9 and other sections.

Each of the enclosing pieces 80A, 80B and the outer conductor crimping pieces 83A, 83B has a set of convex portions (93A, 91B) and recessed portions (92A, 94B) on the side where the enclosing portion 80 and the outer conductor crimping portion 83 are adjacent to each other.

Furthermore, on the side where the enclosing pieces 80A, 80B and the outer conductor crimping pieces 83A, 83B are adjacent to each other, moreover, on the one side “A” of the opposed sides that sandwich the connecting portion 24, a convex portion 93A is provided on the abutting face 81A of the enclosing piece 80A, whereas a recessed portion 92A is provided on the abutting face 86A of the outer conductor crimping piece 83A.

In addition, on said adjacent side, moreover, on the other side “B” of the opposed sides that sandwich the connecting portion 24, the recessed portion 94B is provided on the abutting face 81B of the enclosing piece 80B and the convex portion 91B is provided on the abutting face 86B of the outer conductor crimping piece 83A.

To improve the radio-frequency characteristics of the coaxial cable connector, it is particularly preferable for the core wire 97 of the coaxial cable 9 and the insulator 95 to be completely covered by the outer conductor shell 70. However, there is a risk that the core wire 97 could be exposed in the vicinity of the boundary with the insulator 95 because a stepped portion 90 is formed between the section that covers the core wire 97 and the section that covers the outer conductor (braid) 93 and the insulator 95 due to differences in the diameter of the coaxial cable and, in addition, when stamping the metal sheet, gaps 89A, 89B of corresponding sizes are produced by stamping between the enclosing pieces 80A, 80B and the outer conductor crimping pieces 83A, 83B. In the present embodiment, in order to prevent exposure of the core wire 97, protruding portions 80aA, 80aB protruding toward the outer conductor crimping portion 83 along the axial direction “α” are provided in the enclosing pieces 80A, 80B, whereas indented portions 83aA, 83aB indented away from the enclosing portion 80 along the axial direction “α” are provided in alignment with these protruding portions 80aA, 80aB in the outer conductor crimping portion 83. As a result, in the present embodiment, as best shown in FIG. 2, the protruding portions 80aA, 80aB and, more specifically, their rear ends, are located proximate to the front end 93a of the braid 93 along the axial direction “α”, and much of the insulator 95 of the coaxial cable 9 susceptible to external signals can be covered by the outer conductor shell 70.

More specifically, on the side where the enclosing pieces 80A, 80B and the outer conductor crimping pieces 83A, 83B are adjacent to each other, moreover, on the one side “A” of the opposed sides that sandwich the connecting portion 24, the convex portion 93A of the enclosing piece 80A has a protruding portion 80aA protruding toward the outer conductor crimping piece 83A along the axial direction “α”, whereas the outer conductor crimping piece 83A has, in alignment with the protruding portion 80aA, an indented portion 83aA indented away from the enclosing piece 80A along the axial direction “α”. In a similar manner, on the side where the enclosing pieces 80A, 80B and the outer conductor crimping pieces 83A, 83B are adjacent to each other, moreover, on the other side “B” of the opposed sides that sandwich the connecting portion 24, the recessed portion 94B of the enclosing piece 80B has a protruding portion 80aB protruding toward the outer conductor crimping piece 83B along the axial direction “α”, whereas the outer conductor crimping piece 83B has, in alignment with the protruding portion 80aB, an indented portion 83aB indented away from the enclosing piece 80B along the axial direction “α”. It should be noted that these protruding portions 80aA, 80aB and indented portions 83aA, 83aB are shaped to have notched portions in alignment with the stepped portion 90. By using such a configuration, the gap between the enclosing pieces 80A, 80B and the outer conductor crimping pieces 83A, 83B is shifted away from the core wire 97, that is, toward the side of the insulator 95 where the effects are less pronounced in the case of exposure to the outside environment, thereby preventing exposure of the core wire 97 and improving radio-frequency characteristics.

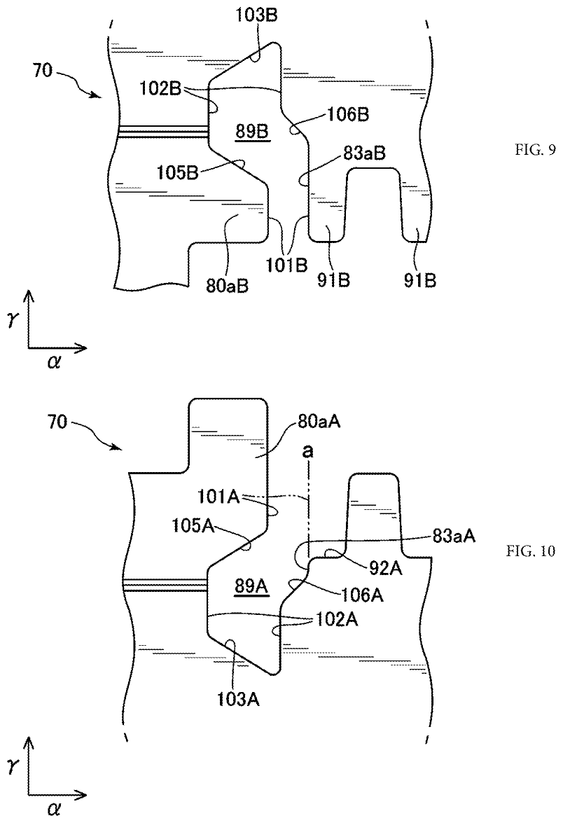

FIG. 9 and FIG. 10 show partial enlarged views of FIG. 5. FIG. 9 is a partial enlarged view of the periphery of the gap 89B, and FIG. 10 is a partial enlarged view of the periphery of the gap 89A.

As shown in FIG. 9, the gap 89B includes a minor slot 101B, which is laterally open and has a relatively small width in the “α” direction; a major slot 102B, which is closed inside of the minor slot 101B in the “γ” direction and has a relatively large width in the “α” direction; an inclined face 103B formed at an innermost location in the “γ” direction; and two coupling portions coupling the minor slot 101B and the major slot 102B, i.e., more specifically, a relatively long coupling portion 105B, which is located toward the front in the “α” direction and is formed by the enclosing piece 80B; and a relatively short coupling portion 106B, which is located toward the rear in the “α” direction and is formed by the outer conductor crimping piece 83B.

As shown in FIG. 10, in a similar manner, the gap 89A includes a minor slot 101A, a major slot 102A, an inclined face 103A, a coupling portion 105A, and a coupling portion 106A. Although the minor slot 101A in the gap 89A appears to have a larger width than the major slot 102A, this is due to the fact that, while the convex portion 91B is provided in the gap 89B, the minor slot 101A is interrupted midway therethrough because the recessed portion 92A is provided in the gap 89A. As described above, the order of the recessed and convex portions provided on the abutting face 81A of the enclosing piece 80A and the order of the recessed and convex portions provided on the abutting face 81B of the enclosing piece 80B may be transposed. Therefore, in essence, a minor slot 101A with a width such as the one indicated by the imaginary line “α” can also be considered to be provided in the gap 89A substantially in the same manner as in the gap 89B.

When the state illustrated in FIG. 4 and FIG. 6 is produced by draw-bending the metal sheet illustrated in FIG. 5 along the one-dot chain lines drawn to indicate expansion and contraction in the “γ” direction, the innermost inclined face 103B is disposed at a rearward-downward inclination and the fracture surface of the sheet faces upward. In addition, in the plane formed by the “α” and “γ” directions, the inclined face 103B slopes toward the center and reduces the distance to the center conductor of the coaxial cable, with the diameter shrinking in the direction from the enclosing portion 80 to the outer conductor crimping portion 83. The heightwise position of the front end 103a of the inclined face 103B in the “β” direction in this state is set to the same upright position with respect to the enclosing pieces 80A, 80B. In addition, the heightwise position of the rear end 103b of the inclined face 103B in the “β” direction in this state is set to the same upright position with respect to the outer conductor crimping pieces 83A, 83B, thereby enabling their precise crimping.

The housing 40 consists essentially of a main body portion 44 that has a substantially cubic shape, a cylindrical mating portion 42 provided at the distal end of the main body portion 44, a mounting portion 43 provided at the rear end of the main body portion 44, and, in addition, paired crimping pieces 50A, 50B. Each of these components is molded integrally with the terminal 20 using a plastic molding process. However, even after integral molding, a portion of the terminal 20, e.g., at least a portion of the contact portion 25 (resilient pieces 25a and the like) and at least a portion of the connecting portion 24 (mounting surface 21) remains exposed to the outside environment.

The mating portion 42, which is a section protruding toward the side of contact with the counterpart coaxial connector, has the contact portion 25 of the terminal 20 disposed in the indentation 48 provided in its center. At the time of mating with the counterpart coaxial connector, the mating portion 42 is inserted into the cylindrical shell of the counterpart coaxial connector and, moreover, the center terminal disposed in the center of the cylindrical shell is inserted into and brought in contact with the contact portion 25 disposed in the center of the mating portion 42.

The paired crimping pieces 50A, 50B are provided on the opposed sides that sandwich the mounting surface 21 in a manner permitting rotation centered, respectively, about folds 55A, 55B that extend along the axial direction “α” of the coaxial cable toward the mounting surface 21, i.e., in the directions “θ_{A}” and “θ_{B}” illustrated in the drawing. These crimping pieces 50A, 50B respectively include opposed faces 51A, 51B (surfaces formed by the “α” and “β” directions in FIGS. 2, 4, 7, etc.) opposing the mounting surface 21 when the paired crimping pieces 50A, 50B are rotated and abutting faces 52A, 52B (surfaces formed by the “α” and “γ” directions in FIGS. 2, 4, 7, etc.) brought into abutment and collision with the counterpart crimping pieces when the paired crimping pieces 50A, 50B are similarly rotated. Here, the facing direction, in which the mounting surface 21 and the opposed faces 51A, 51B face each other when the paired crimping pieces 50A, 50B are rotated, is substantially identical to the mating direction “0”, in which the coaxial cable connector 1 and the counterpart coaxial connector are mated. As a result of collision of at least some portions of the abutting faces 52A, 52B, the core wire 97 of the coaxial cable sandwiched between the mounting surface 21 and the opposed faces 51A, 51B in the facing direction “β” can be efficiently prevented from escaping from the gap of the abutting faces 52A, 52B.

Protruding portions 51aA, 51aB, which protrude toward the mounting surface 21, are respectively provided on the opposed faces 51A, 51B in the “β (or γ)” direction intersecting with the folds 55A, 55B. Providing the protruding portions 51aA, 51aB can enhance the pushing force of the opposed faces 51A, 51B with respect to the mounting surface 21 in the section where these protruding portions 51aA, 51aB are provided.

A protruding portion 21a, which protrudes toward the opposed faces 51A, 51B, may be provided on the mounting surface 21. Providing the protruding portion 21a can enhance the pushing force of the mounting surface 21 with respect to the opposed faces 51A, 51B.

Recessed portions 54A, 54B, which engage with convex portions 53A, 53B provided on the abutting faces 52B, 52A of the counterpart crimping pieces 50B, 50A when the paired crimping pieces 50A, 50B are rotated, are provided on at least one of the abutting faces 52A, 52B of the paired crimping pieces 50A, 50B. The convex portions 53A, 53B and the recessed portions 54A, 54B may be respectively provided so as to be capable of colliding with each other on the abutting sides of the abutting faces 52A, 52B.

In the illustrated example, a total of three portions, i.e., a convex portion 53A, a recessed portion 54A, and a convex portion 53A, are provided in this order in an alternating manner along the direction “α” of the folds 55A, 55B on the abutting face 52A and, in alignment therewith, a total of three portions, i.e., a recessed portion 54B, a convex portion 53B, and a recessed portion 54B, are similarly provided in this order on the abutting face 52B. There are no specific limitations as to the number of such recessed and convex portions, such that only one recessed or convex portion, or a plurality of recessed and convex portions, may be provided on each of the abutting faces 52A, 52B.

Covering portions 60A, 60B are respectively provided on the sides of the recessed portions 54A, 54B opposite to the opposed faces 51A, 51B. When the paired crimping pieces 50A, 50B are rotated and the convex portions 53B, 53A are brought into engagement with the recessed portions 54A, 54B, these covering portions 60A, 60B can cover the engagement portion of the recessed and convex portions from the top and, moreover, are capable of colliding with each other on the abutting sides of the abutting faces 52A, 52B. Providing such covering portions 60A, 60B can prevent the ingress of dust and the like through gaps that may be produced along the engagement portion by closing such gaps, thus making it possible to increase the contact reliability of the connector.

Quite naturally, the present invention is not limited to the above-described embodiments and allows for a variety of modifications. Therefore, various modifications that would normally occur to one skilled in the art fall within the scope of the inventive claims.

### DESCRIPTION OF THE REFERENCE NUMERALS

1 Coaxial cable connector
9 Coaxial cable
20 Terminal
21 Mounting surface
24 Connecting portion
25 Contact portion
40 Housing
50A, 50B Crimping pieces
70 Outer conductor shell
80A, 80B Enclosing pieces (first crimping pieces)
80aA, 80aB Protruding portions
81A, 81B Abutting faces
83A, 83B Outer conductor crimping pieces (second crimping pieces)
83aA, 83aB Indented portions
86A, 86B Abutting faces
90 Stepped portion

1. A coaxial cable connector comprising:
a terminal,
a housing that supports the terminal, and
an outer conductor shell that covers the exterior of the housing, wherein
the terminal comprises a connecting portion exposed from the housing;
the outer conductor shell comprises a first crimping portion and a second crimping portion provided in a manner permitting deformation toward a coaxial cable connected to the connecting portion and successively spaced apart from each other along the axial direction of the coaxial cable connected to the connecting portion from one end toward the other end of the coaxial cable;
the first crimping portion comprises protruding portions that are positioned in the axial direction at the corresponding locations of the connecting portion and protrude in the axial direction toward the second crimping portion; and
the second crimping portion comprises, in alignment with the protruding portions, indented portions indented away from the first crimping portion in the axial direction.

2. The coaxial cable connector according to claim 1, wherein
both the first crimping portion and the second crimping portion are comprised by paired crimping pieces provided in a manner permitting deformation toward the coaxial cable connected to the connecting portion;
each of the crimping pieces constituting the paired crimping pieces, on each of the opposed sides that sandwich the connecting portion, comprises an abutting face brought into abutment against a counterpart crimping piece upon deformation toward the coaxial cable connected to the connecting portion; and
convex portions, which engage with recessed portions provided on the abutting face of a counterpart crimping piece when the paired crimping pieces are deformed toward the coaxial cable connected to the connecting portion, are provided on at least one of the abutting faces of the paired crimping pieces.

3. The coaxial cable connector according to claim 2, wherein,
on one of the opposed sides that sandwich the connecting portion, moreover, on the side where the first crimping portion and the second crimping portion are adjacent to each other, the convex portions are provided on the abutting face of one crimping piece of the first crimping portion and the recessed portions are provided on the abutting face of one crimping piece of the second crimping portion; and,
on the other one of the opposed sides that sandwich the connecting portion, moreover, on the side where the first crimping portion and the second crimping portion are adjacent to each other, the recessed portions are provided on the abutting face of the other crimping piece of the first crimping portion and the convex portions are provided on the abutting face of the other crimping piece of the second crimping portion.

4. The coaxial cable connector according to claim 2, wherein, upon deformation of each crimping piece constituting the paired crimping pieces toward the coaxial cable connected to the connecting portion, the convex portions and the recessed portions are engaged with each other in a circumferential direction about the axial line of the coaxial cable at the corresponding locations of the connecting portion.

5. The coaxial cable connector according to claim 1, wherein, upon deformation of each crimping piece constituting the paired crimping pieces toward the coaxial cable connected to the connecting portion, the length of the first crimping portion in the width direction connecting one of the opposed sides that sandwich the connecting portion and the other side is longer than the length of the second crimping portion in the width direction, and a stepped portion is formed in the axial direction between the first crimping portion and the second crimping portion.

6. The coaxial cable connector according to claim 1, wherein the first crimping portion and the second crimping portion of the outer conductor shell are formed from a single metal sheet.
